(19) United States
(12) Patent Application Publication
(10) Pub. No.: US 2026/0311628 A1
(43) Pub. Date: Oct. 8, 2026

(54) DISPLAY DEVICE AND OPERATING METHOD THEREOF

(71) Applicant: Industrial Technology Research Institute, Hsinchu (TW)

(72) Inventors: Chen-Wei Lin, Hsinchu City (TW); Wei-Chung Chen, Kaohsiung City (TW); Ruo-Lan Chang, New Taipei City (TW); Kung-Ching Chu, Taipei City (TW)

(73) Assignee: Industrial Technology Research Institute, Hsinchu (TW)

(21) Appl. No.: 19/452,369

(22) Filed: Jan. 18, 2026

(30) Foreign Application Priority Data
Apr. 2, 2025 (TW) 114112746

(51) Int. Cl. G09G 3/20

(52) U.S. Cl. CPC G09G 3/2096; G09G 2310/08; G09G 2340/0464; G09G 2380/10

(57) ABSTRACT

Provided are a display device and an operating method thereof. The display device includes a display panel, a sensing device, and a display controller and driver. The display panel has a screen display region. The screen display region is smaller than a displayable region of the display panel. The sensing device is configured to sense multiple vibration levels of the display panel respectively in different directions to obtain a vibration information. The display controller and driver is configured to adjust a position of the screen display region according to the vibration information. A gate driver adjusts a position on the display panel to which multiple gate drive signals are transmitted according to the vibration information. A source driver adjusts a position on the display panel to which multiple display data are transmitted according to the vibration information. A reset circuit provides multiple reset voltages according to a reset signal.

### CROSS-REFERENCE TO RELATED APPLICATION

This application claims the priority benefit of Taiwan application serial no. 114112746, filed on April 2, 2025. The entirety of the above-mentioned patent application is hereby incorporated by reference herein and made a part of this specification.

### TECHNICAL FIELD

The disclosure relates to a display technology, and in particular relates to a display device and an operating method thereof.

### BACKGROUND

In daily life, people are accustomed to using related electronic equipment on moving vehicles or transportations. However, when the cabin of the vehicle or other transportation wobbles due to uncontrollable external environmental factors, a condition of dizziness may be easily generated in a user’ brain when a direction of movement does not match an expected or received sensory message.

In response to this, an output display screen is usually compensated through software technology in prior art when the electronic equipment wobbles. However, in practice, prior art may need higher hardware computing capability, thereby leading to a cost increase. In addition, a computing time needed by software technology also might cause a time lag between the image and the wobbling condition, thereby reducing the effect of screen compensation.

In view of this, how to effectively improve motion sickness caused by wobbling of a display device, and reduce the need for hardware computing capability as well as reduce the computing time of an overall circuit in order to enhance the viewing quality of a display screen is an important topic for those skilled in the art.

### SUMMARY

The disclosure provides a display device and an operating method thereof, which can set a position of a start signal of a gate drive circuit and adjust a pin for a source driver to transmit a display information according to a vibration information that is transmitted by a sensor to the display device in order to adjust a position of a screen display region when the display device wobbles, thereby effectively enhancing the viewing quality of a display screen.

The display device of the disclosure includes a display panel, a sensing device, and a display controller and driver. The display panel has a screen display region. The screen display region is smaller than a displayable region of the display panel. The sensing device is configured to sense multiple vibration levels of the display panel respectively in different directions to obtain a vibration information. The display controller and driver is coupled to the display panel and the sensing device, and configured to adjust a position of the screen display region according to the vibration information. The display controller and driver includes a gate driver, a source driver, and a reset circuit. The gate driver is configured to adjust a position on the display panel to which multiple gate drive signals are transmitted according to the vibration information. The source driver is configured to adjust a position on the display panel to which multiple display data are transmitted according to the vibration information. The reset circuit is coupled to the source driver, the gate driver, and the display panel, and configured to receive a reset signal and provide multiple reset voltages according to the reset signal to respectively reset multiple pixel voltages of multiple pixels of the display panel.

The method of operating the display device of the disclosure includes: a display panel having a screen display region is provided; the screen display region is smaller than a displayable region of the display panel; a sensing device is allowed to sense multiple vibration levels of the display panel respectively in different directions to obtain a vibration information; a display controller and driver is allowed to adjust a position of the screen display region according to the vibration information; a gate driver of the display controller and driver is allowed to adjust a position on the display panel to which multiple gate drive signals are transmitted according to the vibration information; a source driver of the display controller and driver is allowed to adjust a position on the display panel to which multiple display data are transmitted according to the vibration information; and a reset circuit of the display controller and driver is allowed to receive a reset signal, and the reset circuit is allowed to provide multiple reset voltages according to the reset signal to respectively reset multiple pixel voltages of multiple pixels of the display panel.

Based on the above, the display device and the operating method according to the embodiments of the disclosure may move the screen display region of the display panel along a direction of vertical vibration from an originally set position based on a position of a selected gate drive circuit that receives a start signal to compensate the display screen in a vertical direction when the display panel vibrates along a vertical direction. A controller of the display device may adjust an input pin for transmitting multiple source display signals when the display panel vibrates in a horizontal direction. For example, an original input pin of a first source line to a 1920th source line is adjusted to an input of a 5th source line to a 1925th source line to achieve a horizontal displacement of the display screen, compensating the display screen in the horizontal direction. In this way, a direction of movement of the display screen viewed by the user can match an expected sensory message, thereby improving the motion sickness phenomenon caused by wobbling of the display device in order to enhance the viewing quality of the display screen.

### BRIEF DESCRIPTION OF THE DRAWINGS

FIG. 1 is a schematic diagram of a display device according to an embodiment of the disclosure.

FIG. 2A to FIG. 2E are respectively schematic diagrams of operating scenarios when the display panel vibrates in a vertical direction according to the embodiments of FIG. 1.

FIG. 3A to FIG. 3E are respectively timing diagrams of the gate drive signals according to the embodiments of FIG. 2A to FIG. 2E.

FIG. 4A to FIG. 4B are respectively schematic diagrams of operating scenarios when the display panel vibrates in a horizontal direction according to the embodiments of FIG. 1.

FIG. 5 is a schematic diagram of a display device according to another embodiment of the disclosure.

FIG. 6 is a flow chart of a method of operating a display device according to an embodiment of the disclosure.

### DETAILED DESCRIPTION OF DISCLOSURED EMBODIMENTS

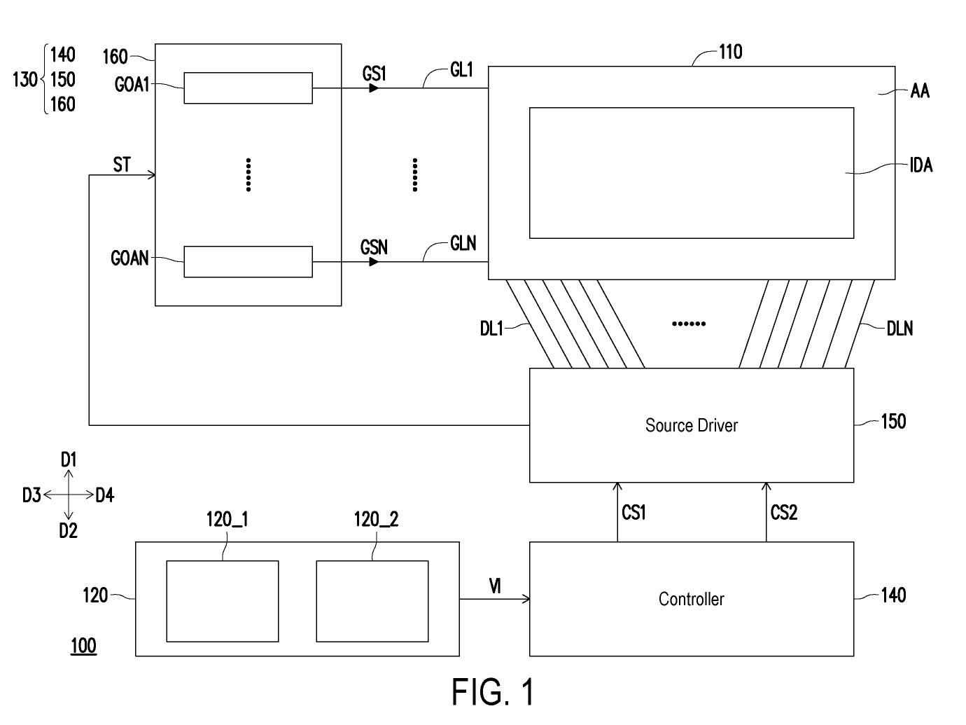

FIG. 1 is a schematic diagram of a display device according to an embodiment of the disclosure. Referring to FIG. 1, a display device 100 includes a display panel 110, a sensor device 120, and a display controller and driver 130. The display device 100 of the embodiment may be, for example, a smartphone, a laptop computer, a tablet computer, a car window type transparent display, a car display, or a seatback display, but the disclosure is not limited thereto.

In the embodiment, the display panel 110 has a displayable region AA (that is, an active area of the display panel 110) and a screen display region IDA. The screen display region IDA of the display panel 110 may be disposed within the displayable region AA. The displayable region AA of the display panel 110 includes multiple pixels (not shown), multiple gate lines GL1 to GLN, and multiple source lines DL1 to DLN. The foregoing N is a positive integer. Those skilled in the art may set a quantity of the pixels, the gate lines, and the source lines in the display panel 110 according to a design need of the display device 100.

It is worth mentioning that, in the embodiment, the screen display region IDA of the display panel 110 is smaller than the displayable region AA of the display panel 110. That is to say, a quantity of pixels (or coverage range) in the displayable region AA of the display panel 110 may be greater than a quantity of pixels (or coverage range) in the screen display region IDA of the display panel 110. The display panel 110 of the embodiment may be, for example, a device with display functions such as a liquid-crystal display (LCD) panel or an organic light-emitting diode (OLED) panel, but the disclosure is not limited thereto.

The sensor device 120 is coupled to the display panel 110. In the embodiment, the sensor device 120 may be configured to sense multiple vibration levels of the display panel 110 respectively in different directions (that is, directions D1, D2, D3, or D4). The sensor device 120 may obtain a vibration information VI according to the vibration levels, and provide the vibration information VI to the display controller and driver 130.

For example, in some embodiments, the sensor device 120 may include a sensor 120_1 and a sensor 120_2. The sensor 120_1 may be configured to sense a vibration level of the display panel 110 in a vertical direction (that is, the directions D1 and D2), while the sensor 120_2 may be configured to sense a vibration level of the display panel 110 in a horizontal direction (that is, the directions D3 and D4). In other embodiments, the sensor device 120 may also only include one sensor 120_1. The sensor 120_1 may sense a vibration level of the display panel 110 in a vertical direction (that is, the directions D1 and D2) and a horizontal direction (that is, the directions D3 and D4) at the same time.

In the following embodiments, the sensor device 120 that includes the sensor 120_1 and the sensor 120_2 will be taken as an example for description. In addition, in the embodiment, the sensor 120_1 and the sensor 120_2 may be, for example, piezoelectric ceramic vibration sensors, spring-type motion sensors, normally-closed vibration sensors, gravity sensors (G sensors), or gyroscopes, but the disclosure is not limited thereto.

On the other hand, the display controller and driver 130 is coupled between the display panel 110 and the sensor device 120. In the embodiment, the display controller and driver 130 may receive the vibration information VI. The display controller and driver 130 may adjust a position of the screen display region IDA of the display panel 110 according to the vibration information VI (that is, the vibration level of the display panel 110 along the vertical direction and/or the vibration level of the display panel 110 along the horizontal direction).

For example, when the sensor device 120 senses that no obvious vibration state has occurred in the display panel 110 in the vertical direction and the horizontal direction, the display controller and driver 130 may, according to the vibration information VI, allow a center position of the screen display region IDA of the display panel 110 to be disposed to overlap with a center position of the displayable region AA of the display panel 110 according to an originally set ratio (as shown in the display panel 110 of FIG. 1).

In addition, when the sensor device 120 senses that the display panel 110 vibrates (that is, vibrates upward) along a first direction (that is, the direction D1) of the vertical direction (that is, the directions D1 and D2), the display controller and driver 130 may, according to the vibration information VI, allow the screen display region IDA of the display panel 110 to move along the first direction D1 (that is, move upward) from an originally set position. Furthermore, when the sensor device 120 senses that the display panel 110 vibrates (that is, vibrates downward) along a second direction (that is, the direction D2) of the vertical direction (that is, the directions D1 and D2), the display controller and driver 130 may, according to the vibration information VI, allow the screen display region IDA of the display panel 110 to move along the second direction D2 (that is, move downward) from an originally set position.

On the other hand, when the sensor device 120 senses that the display panel 110 vibrates (that is, vibrates leftward) along a third direction (that is, the direction D3) of the horizontal direction (that is, the directions D3 and D4), the display controller and driver 130 may, according to the vibration information VI, allow the screen display region IDA of the display panel 110 to move along the third direction D3 (that is, move leftward) from an originally set position. Furthermore, when the sensor device 120 senses that the display panel 110 vibrates (that is, vibrates rightward) along a fourth direction (that is, the direction D4) of the horizontal direction (that is, the directions D3 and D4), the display controller and driver 130 may, according to the vibration information VI, allow the screen display region IDA of the display panel 110 to move along the fourth direction D4 (that is, move rightward) from an originally set position.

Furthermore, in the embodiment shown in FIG. 1, the display controller and driver 130 may include a controller 140, a source driver 150, and a gate driver 160. The controller 140 is coupled between the sensor device 120 and the source driver 150. The controller 140 of the embodiment may be, for example, a timing controller.

In the embodiment, the controller 140 may receive the vibration information VI. The controller 140 may obtain a vertical vibration level VVD of the display panel 110 vibrating along the vertical direction from the sensor 120_1 according to the vibration information VI. Next, the controller 140 may compare the vertical vibration level VVD with a preset vertical vibration threshold VVT, and generate a control signal CS1 to the source driver 150 according to a comparison result.

On the other hand, the controller 140 may obtain a horizontal vibration level HVD of the display panel 110 vibrating along the horizontal direction from the sensor 120_2 according to the vibration information VI. Next, the controller 140 may compare the horizontal vibration level HVD with a preset horizontal vibration threshold HVT, and generate a control signal CS2 to the source driver 150 according to a comparison result.

In other words, in the embodiment, the control signal CS1 and the vibration information VI may be configured to indicate whether the display panel 110 has a state of vibration along the vertical direction, and the vertical vibration level VVD of the display panel 110 vibrating along the vertical direction. In addition, the control signal CS2 and the vibration information VI may be configured to indicate whether the display panel 110 has a state of vibration along the horizontal direction, and the horizontal vibration level HVD of the display panel 110 vibrating along the horizontal direction.

On the other hand, the gate driver 160 is coupled to the multiple gate lines GL1 to GLN and the source driver 150 of the display panel 110. The gate driver 160 includes multiple gate drive circuits GOA1 to GOAN connected in series. One gate drive circuit among the gate drive circuits GOA1 to GOAN may receive a start signal ST, so that the gate driver 160 may generate multiple gate drive signals GS1 to GSN to the multiple gate lines GL1 to GLN according to the start signal ST to respectively drive multiple pixels corresponding to the screen display region IDA.

On the other hand, the source driver 150 is coupled between the controller 140, the multiple source lines DL1 to DLN of the display panel 110, and the gate driver 160. In the embodiment, the source driver 150 may receive the control signal CS1. The source driver 150 may select to transmit the start signal ST to one of the gate drive circuits GOA1 to GOAN according to an indication of the control signal CS1. In addition, the source driver 150 may receive the control signal CS2. The source driver 150 may transmit multiple display data to multiple first source lines and multiple second source lines among the multiple source lines DL1 to DLN of the display panel 110 according to the control signal CS2.

In this way, the display device 100 of the embodiment may adjust the position of the screen display region IDA of the display panel 110 based on the indication of the control signals CS1 and CS2, and according to a position to which all or a portion of the gate drive signals GS1 to GSN and the multiple display data are transmitted.

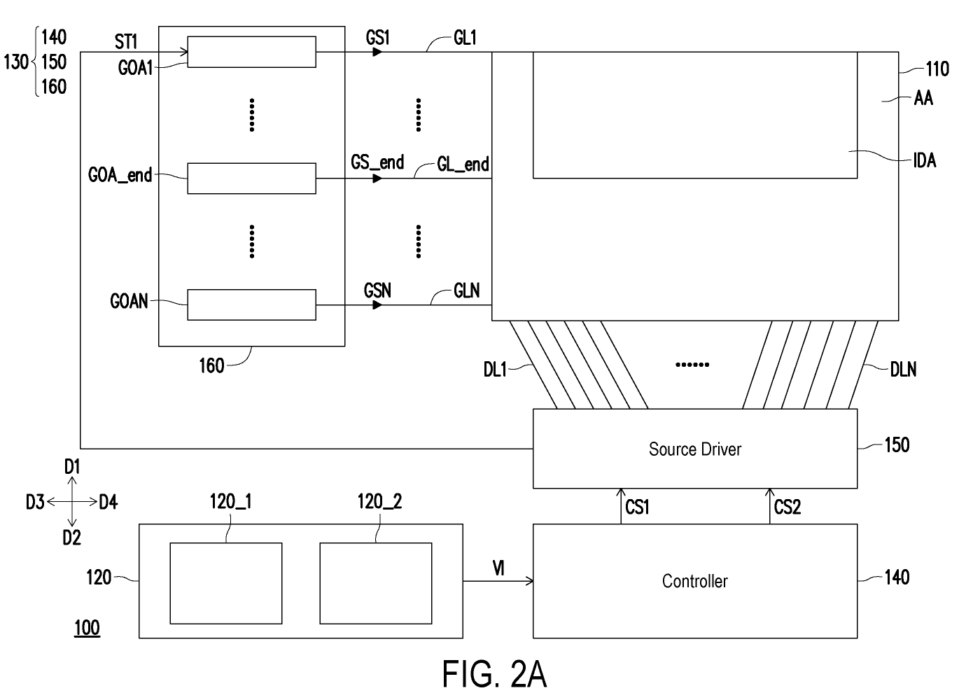

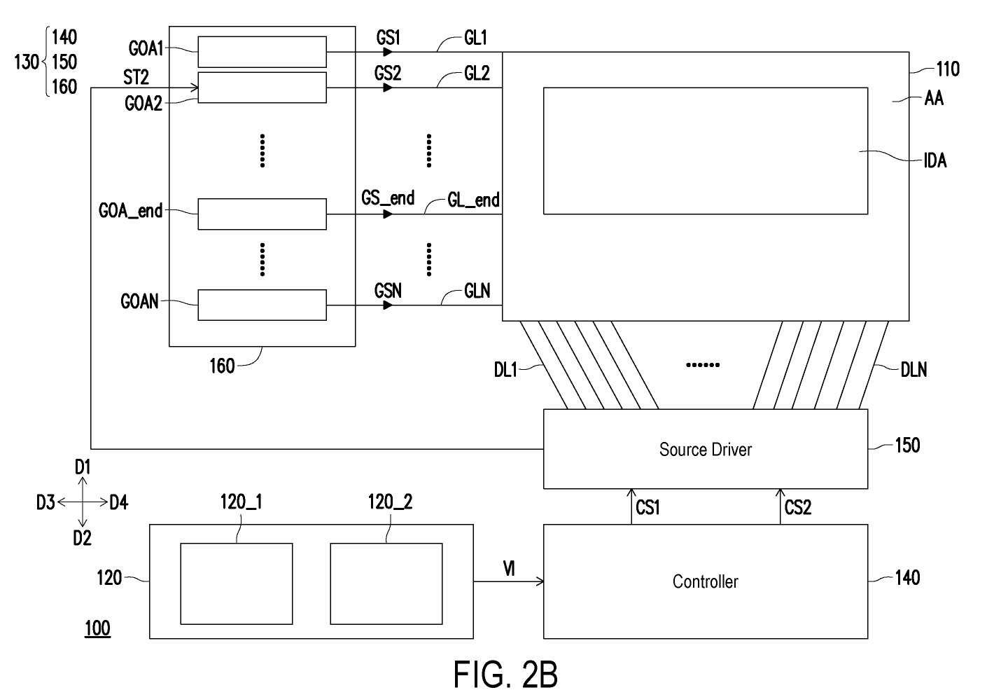

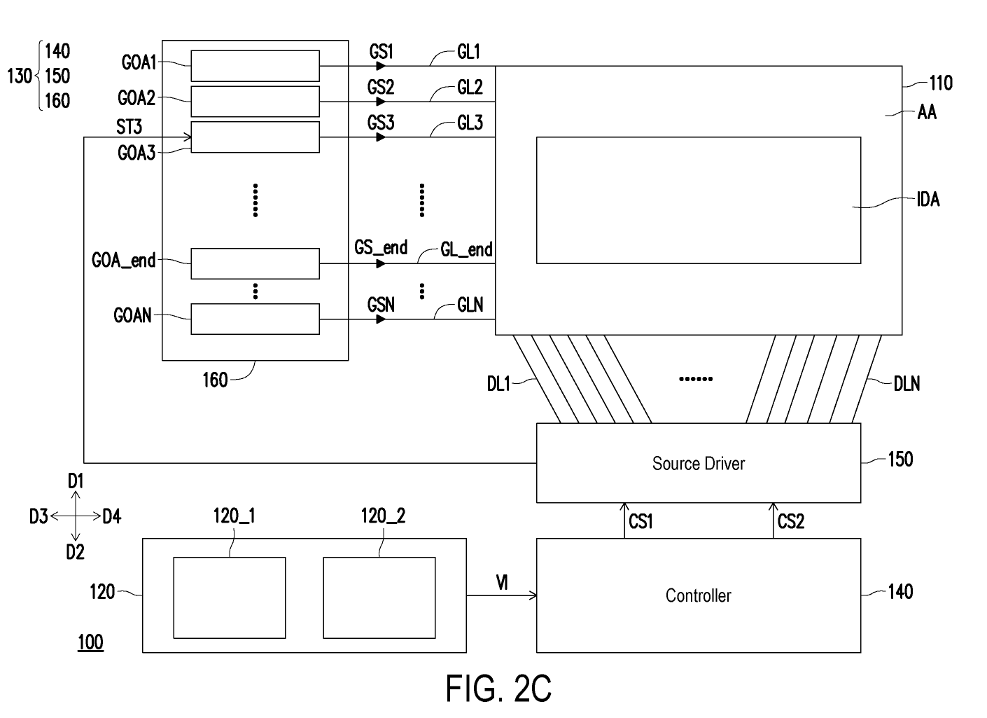

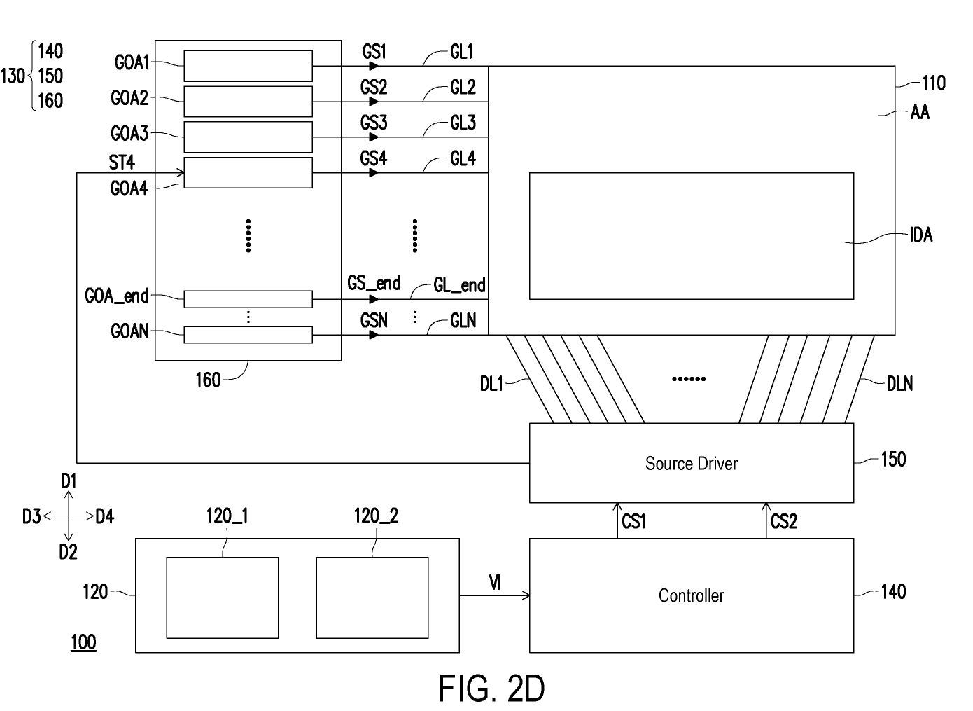

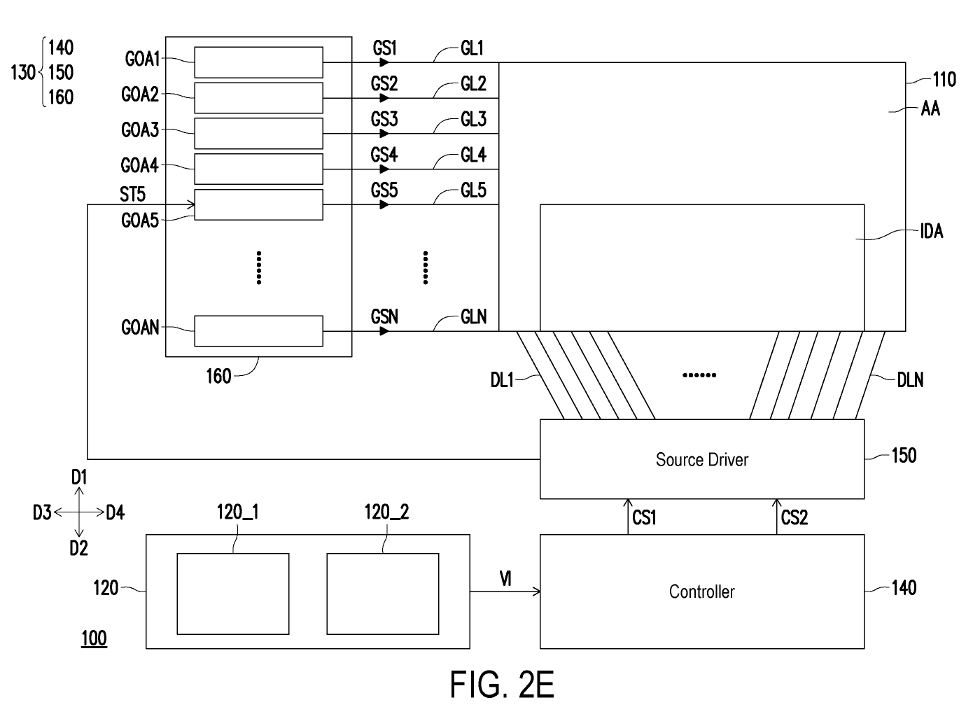

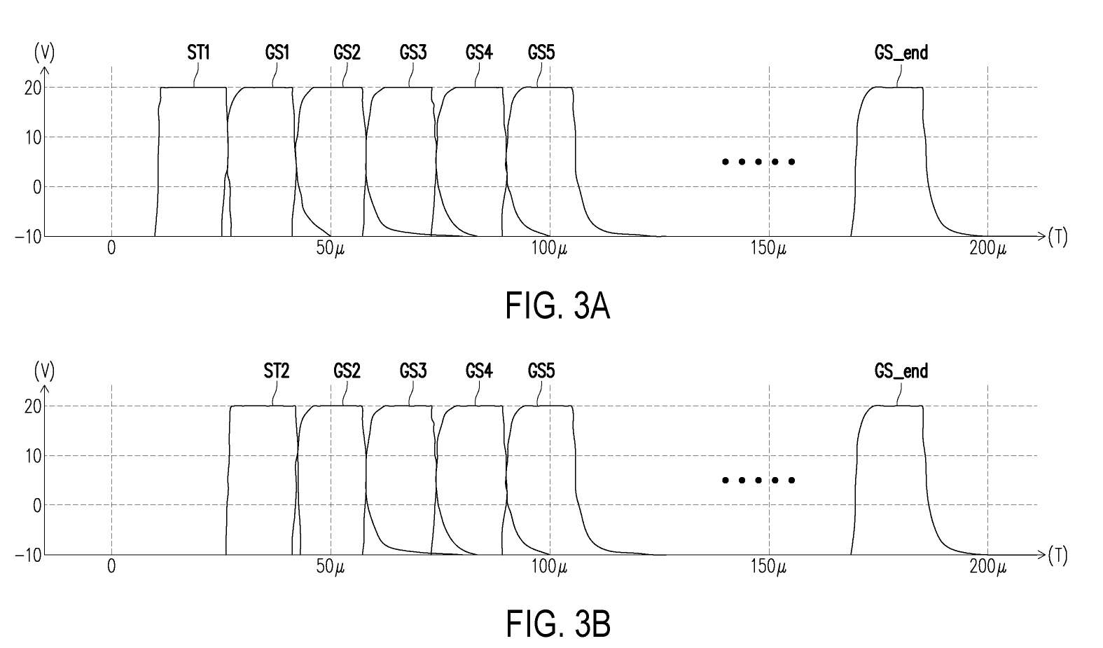

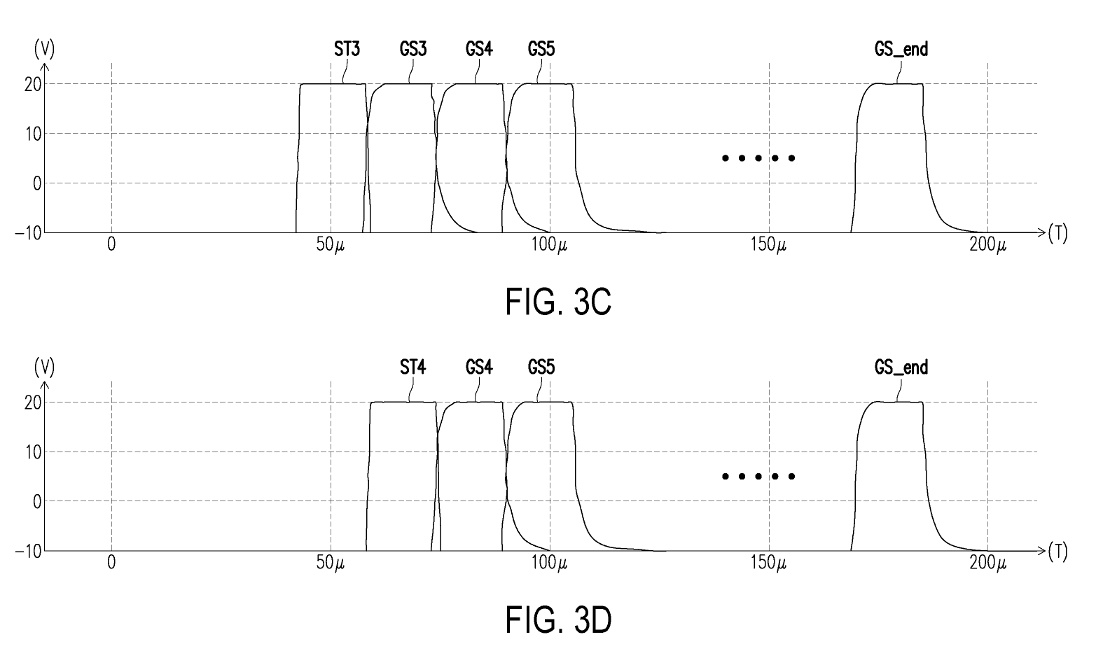

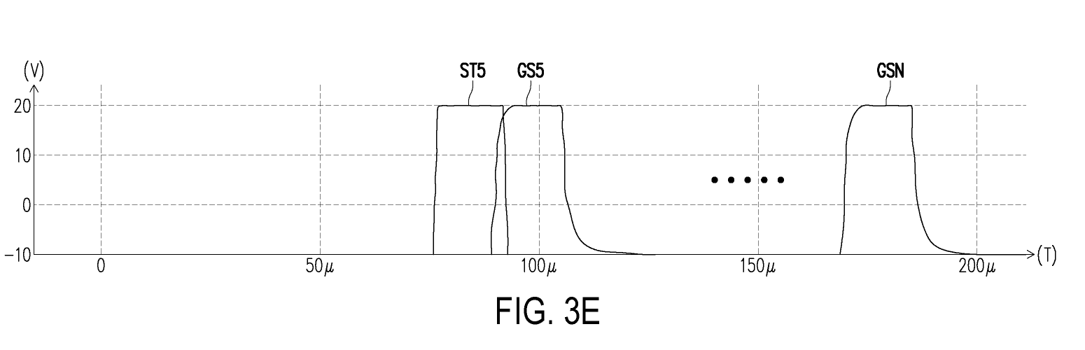

FIG. 2A to FIG. 2E are respectively schematic diagrams of operating scenarios when the display panel vibrates in a vertical direction according to the embodiments of FIG. 1. FIG. 3A to FIG. 3E are respectively timing diagrams of the gate drive signals according to the embodiments of FIG. 2A to FIG. 2E.

In the embodiments of FIG. 2A to FIG. 2E, the embodiments of FIG. 2A to FIG. 2E may be adapted to operating scenarios or scenes where a vibration level of the display panel 110 in a vertical direction is more intense, but a vibration level in a horizontal direction is more moderate. For example, a user uses the display device 100 on a vehicle traveling at a high speed (such as high-speed rail, train, or vehicles driving on highways, etc.).

It should be noted that, in the embodiments of FIG. 2A and FIG. 2B, the embodiments of FIG. 2A and FIG. 2B describe the operating scenarios when the display panel 110 vibrates along a first direction (that is, the direction D1) in the vertical direction (that is, the directions D1 and D2). In the embodiment, a vibration level of the display panel 110 shown in FIG. 2A vibrating along the first direction D1 in the vertical direction may be greater than a vibration level of the display panel 110 shown in FIG. 2B vibrating along the first direction D1 in the vertical direction.

In the embodiment of FIG. 2A, a plurality of pixels or display screen in the screen display region IDA of the display panel 110 can be driven, for example, by the gate drive circuits GOA1 to GOA_end in the gate driver 160. In the embodiment of FIG. 2B, a plurality of pixels or display screen in the screen display region IDA of the display panel 110 can be driven, for example, by the gate drive circuits GOA2 to GOA_end in the gate driver 160.

Moreover, in the embodiment of FIG. 2C, the embodiment of FIG. 2C describes the operating scenario where no obvious vibration state has occurred in the display panel 110 in the vertical direction. In the embodiment of FIG. 2C, a plurality of pixels or display screen in the screen display region IDA of the display panel 110 can be driven, for example, by the gate drive circuits GOA3 to GOA_end in the gate driver 160.

On the other hand, in the embodiments of FIG. 2D and FIG. 2E, the embodiments of FIG. 2D and FIG. 2E describe the operating scenarios when the display panel 110 vibrates along a second direction (that is, the direction D2) in the vertical direction (that is, the directions D1 and D2). In the embodiment, a vibration level of the display panel 110 shown in FIG. 2E vibrating along the second direction D2 in the vertical direction may be greater than a vibration level of the display panel 110 shown in FIG. 2D vibrating along the second direction D2 in the vertical direction.

In the embodiment of FIG. 2D, a plurality of pixels or display screen in the screen display region IDA of the display panel 110 can be driven, for example, by the gate drive circuits GOA4 to GOA_end in the gate driver 160. In the embodiment of FIG. 2E, a plurality of pixels or display screen in the screen display region IDA of the display panel 110 can be driven, for example, by the gate drive circuits GOA5 to GOA_end in the gate driver 160.

In addition, in the timing diagrams of FIG. 3A to FIG. 3E, a horizontal axis of FIG. 3A to FIG. 3E represents an operation time (T) of the display device 100. A vertical axis of FIG. 3A to FIG. 3E represents voltage values (V) of start signals ST1 to ST5 and voltage values (V) of the gate drive signals GS1 to GS_end or GS1 to GSN.

In this regard, please refer to FIG. 2A to FIG. 2C and FIG. 3A to FIG. 3C at the same time. In detail, during a display time interval of one image frame of the display device 100, when the sensor 120_1 of the sensing device 120 senses that the display panel 110 vibrates along a first direction (that is, the direction D1) in the vertical direction (that is, the directions D1 and D2) with a vibration level VDD1, the sensor 120_1 may generate the vibration information VI to the controller 140 according to the vibration level VDD1 of the display panel 110 in the first direction D1.

Next, the controller 140 may compare a vertical vibration level VVD1 with a preset first vertical vibration threshold VVT1 and a second vertical vibration threshold VVT2 according to the vibration information VI, and generate the control signal CS1 to the source driver 150 according to a comparison result. The first vertical vibration threshold VVT1 may be greater than the second vertical vibration threshold VVT2.

For example, when the controller 140 determines that the vertical vibration level VVD1 of the display panel 110 is not greater than the second vertical vibration threshold VVT2, it indicates that no obvious vibration state has occurred in the display panel 110 in the vertical direction. In this condition, as shown in FIG. 2C, the source driver 150 may select the gate drive circuit GOA3 among the multiple gate drive circuits GOA1 to GOA_end to serve as a selected gate drive circuit according to the control signal CS1, and transmit the start signal ST3 to the selected gate drive circuit GOA3.

Next, as shown in the timing diagram of FIG. 3C, the multiple gate drive circuits GOA3 to GOA_end in the gate driver 160 may generate the multiple gate drive signals GS3 to GS_end that are sequentially enabled to the multiple gate lines GL3 to GL_end of the display panel 110 according to the start signal ST3 in order to drive multiple pixels respectively corresponding to the multiple gate lines GL3 to GL_end in the screen display region IDA. In this way, the display panel 110 may display a screen in the screen display region IDA according to the multiple gate drive signals GS3 to GS_end that are sequentially enabled and multiple display data.

At this time, a center position of the screen display region IDA of the display panel 110 may be disposed to overlap with a center position of the displayable region AA of the display panel 110 according to an originally set ratio (as shown in the display panel 110 of FIG. 2C).

It is worth mentioning that, in the embodiments of FIG. 2C and FIG. 3C, the gate drive circuits GOA1 and GOA2 do not generate the gate drive signals GS1 and GS2 to the gate lines GL1 and GL2. In other words, multiple pixels respectively corresponding to the gate lines GL1 and GL2 of the display panel 110 may not be driven. Therefore, the displayable region AA corresponding to the multiple pixels on the gate lines GL1 and GL2 may not display a screen.

On the other hand, when the controller 140 determines that the vertical vibration level VVD1 of the display panel 110 is greater than the second vertical vibration threshold VVT2 and less than the first vertical vibration threshold VVT1, it indicates that a relatively small vibration has occurred in the display panel 110 in the first direction (that is, the direction D1) of the vertical direction (that is, the directions D1 and D2) (that is, an amplitude of the display panel 100 vibrating upward is relatively small).

In this condition, as shown in FIG. 2B, the source driver 150 may select the gate drive circuit GOA2 among the multiple gate drive circuits GOA1 to GOA_end as a selected gate drive circuit according to the control signal CS1, and transmit the start signal ST2 to the selected gate drive circuit GOA2.

Next, as shown in the timing diagram of FIG. 3B, the multiple gate drive circuits GOA2 to GOA_end in the gate driver 160 may generate the multiple gate drive signals GS2 to GS_end that are sequentially enabled to the multiple gate lines GL2 to GL_end of the display panel 110 according to the start signal ST2 in order to drive multiple pixels respectively corresponding to the multiple gate lines GL2 to GL_end in the screen display region IDA. In this way, the display panel 110 may display a screen in the screen display region IDA according to the multiple gate drive signals GS2 to GS_end that are sequentially enabled and multiple display data.

It is worth mentioning that, in the embodiments of FIG. 2B and FIG. 3B, the gate drive circuit GOA1 does not generate the enabled gate drive signal GS1 to the gate line GL1. In other words, multiple pixels corresponding to the gate line GL1 of the display panel 110 may not be driven. Therefore, the displayable region AA corresponding to the multiple pixels on the gate line GL1 may not display a screen.

Furthermore, in the embodiment, when the control signal CS1 indicates that a relatively small vibration has occurred in the display panel 110 in the first direction D1 of the vertical direction, the source driver 150 may adjust to transmit the start signal ST (that is, the start signal ST3 or the start signal ST2) to the selected gate drive circuit GOA2 instead of to the selected gate drive circuit GOA3 according to the control signal CS1. In the gate driver 160, the gate drive circuit GOA2 may be disposed above the gate drive circuit GOA3.

In this way, in the operating scenarios of FIG. 2B and FIG. 2C, the source driver 150 may adjust to transmit the start signal ST to the selected gate drive circuit GOA2 instead of to the selected gate drive circuit GOA3 to allow the screen display region IDA of the display panel 110 to move (that is, move upward) along the first direction D1 with a first movement amplitude MR1 from an originally set position.

On the other hand, when the controller 140 determines that the vertical vibration level VVD1 of the display panel 110 is greater than the first vertical vibration threshold VVT1, it indicates that a relatively large vibration has occurred in the display panel 110 in the first direction (that is, the direction D1) of the vertical direction (that is, the directions D1 and D2) (that is, an amplitude of the display panel 100 vibrating upward is relatively large).

In this condition, as shown in FIG. 2A, the source driver 150 may select the gate drive circuit GOA1 among the multiple gate drive circuits GOA1 to GOA_end as a selected gate drive circuit according to the control signal CS1, and transmit the start signal ST1 to the selected gate drive circuit GOA1.

Next, as shown in the timing diagram of FIG. 3A, the multiple gate drive circuits GOA1 to GOA_end in the gate driver 160 may generate the multiple gate drive signals GS1 to GS_end that are sequentially enabled to the multiple gate lines GL1 to GL_end of the display panel 110 according to the start signal ST1 in order to drive multiple pixels respectively corresponding to the multiple gate lines GL1 to GL_end in the screen display region IDA. In this way, the display panel 110 may display a screen in the screen display region IDA according to the multiple gate drive signals GS1 to GS_end that are sequentially enabled and multiple display data.

Furthermore, in the embodiment, when the control signal CS1 indicates that a relatively large vibration has occurred in the display panel 110 in the first direction D1 of the vertical direction, the source driver 150 may adjust to transmit the start signal ST (that is, the start signal ST1, the start signal ST2 or the start signal ST3) to the selected gate drive circuit GOA1 instead of to the selected gate drive circuit GOA3 (or the selected gate drive circuit GOA2) according to the control signal CS1. In the gate driver 160, the gate drive circuit GOA1 may be disposed above the gate drive circuit GOA3 (or the gate drive circuit GOA2).

In this way, in the operating scenarios of FIG. 2A and FIG. 2C, the source driver 150 may adjust to transmit the start signal ST to the selected gate drive circuit GOA1 instead of to the selected gate drive circuit GOA3 to allow the screen display region IDA of the display panel 110 to move (that is, move upward) along the first direction D1 with a second movement amplitude MR2 from an originally set position. The second movement amplitude MR2 may be greater than the first movement amplitude MR1.

Similarly, please refer to FIG. 2C to FIG. 2E and FIG. 3C to FIG. 3E at the same time. In detail, in a display time interval of an image frame of the display device 100, when the sensor 120_1 of the sensing device 120 senses that the display panel 110 vibrates along a second direction (that is, the direction D2) of the vertical direction (that is, the directions D1 and D2) with a vibration level VDD2, the sensor 120_1 may generate the vibration information VI to the controller 140 according to the vibration level VDD2 of the display panel 110 in the second direction D2.

Next, the controller 140 may compare the vertical vibration level VVD2 with a third vertical vibration threshold VVT3 and a fourth vertical vibration threshold VVT4 that are preset according to the vibration information VI, and generate the control signal CS1 to the source driver 150 according to a comparison result. The third vertical vibration threshold VVT3 may be greater than the fourth vertical vibration threshold VVT4.

For example, when the controller 140 determines that the vertical vibration level VVD2 of the display panel 110 is not greater than the fourth vertical vibration threshold VVT4, it indicates that no obvious vibration state has occurred in the display panel 110 in the vertical direction. In this condition, as shown in FIG. 2C, the source driver 150 may select the gate drive circuit GOA3 among the multiple gate drive circuits GOA1 to GOA_end as a selected gate drive circuit according to the control signal CS1, and transmit the start signal ST3 to the selected gate drive circuit GOA3.

Next, as shown in the timing diagram of FIG. 3C, the multiple gate drive circuits GOA3 to GOA_end in the gate driver 160 may generate the multiple gate drive signals GS3 to GS_end that are sequentially enabled to the multiple gate lines GL3 to GL_end of the display panel 110 according to the start signal ST3 in order to drive multiple pixels respectively corresponding to the multiple gate lines GL3 to GL_end in the screen display region IDA. In this way, the display panel 110 may display a screen in the screen display region IDA according to the multiple gate drive signals GS3 to GS_end that are sequentially enabled and multiple display data.

At this time, a center position of the screen display region IDA of the display panel 110 may be disposed to overlap with a center position of the displayable region AA of the display panel 110 according to an originally set ratio (as shown in the display panel 110 of FIG. 2C).

It is worth mentioning that, in the embodiments of FIG. 2C and FIG. 3C, the gate drive circuits GOA1 and GOA2 do not generate the enabled gate drive signals GS1 and GS2 to the gate lines GL1 and GL2. In other words, multiple pixels respectively corresponding to the gate lines GL1 and GL2 of the display panel 110 may not be driven. Therefore, the displayable region AA corresponding to the multiple pixels on the gate lines GL1 and GL2 may not display a screen.

On the other hand, when the controller 140 determines that the vertical vibration level VVD2 of the display panel 110 is greater than the fourth vertical vibration threshold VVT4 and less than the third vertical vibration threshold VVT3, it indicates that a relatively small vibration has occurred in the display panel 110 in the second direction (that is, the direction D2) of the vertical direction (that is, the directions D1 and D2) (that is, an amplitude of the display panel 100 vibrating downward is relatively small).

In this condition, as shown in FIG. 2D, the source driver 150 may select the gate drive circuit GOA4 among the multiple gate drive circuits GOA1 to GOA_end as a selected gate drive circuit according to the control signal CS1, and transmit the start signal ST4 to the selected gate drive circuit GOA4.

Next, as shown in the timing diagram of FIG. 3D, the multiple gate drive circuits GOA4 to GOA_end in the gate driver 160 may generate the multiple gate drive signals GS4 to GS_end that are sequentially enabled to the multiple gate lines GL4 to GL_end of the display panel 110 according to the start signal ST4 in order to drive multiple pixels respectively corresponding to the multiple gate lines GL4 to GL_end in the screen display region IDA. In this way, the display panel 110 may display a screen in the screen display region IDA according to the multiple gate drive signals GS4 to GS_end that are sequentially enabled and multiple display data.

It is worth mentioning that, in the embodiments of FIG. 2D and FIG. 3D, the gate drive circuits GOA1 to GOA3 do not generate the enabled gate drive signals GS1 to GS3 to the gate lines GL1 to GL3. In other words, multiple pixels respectively corresponding to the gate lines GL1 to GL3 of the display panel 110 may not be driven. Therefore, the displayable region AA corresponding to the multiple pixels on the gate lines GL1 to GL3 may not display a screen.

Furthermore, in the embodiment, when the control signal CS1 indicates that a relatively small vibration has occurred in the display panel 110 in the second direction D2 of the vertical direction, the source driver 150 may adjust to transmit the start signal ST (that is, the start signal ST3 or the start signal ST4) to the selected gate drive circuit GOA4 instead of to the selected gate drive circuit GOA3 according to the control signal CS1. In the gate driver 160, the gate drive circuit GOA4 may be disposed below the gate drive circuit GOA3.

In this way, in the operating scenarios of FIG. 2C and FIG. 2D, the source driver 150 may adjust to transmit the start signal ST to the selected gate drive circuit GOA4 instead of to the selected gate drive circuit GOA3 to allow the screen display region IDA of the display panel 110 to move (that is, move downward) along the second direction D2 with a third movement amplitude MR3 from an originally set position.

On the other hand, when the controller 140 determines that the vertical vibration level VVD2 of the display panel 110 is greater than the third vertical vibration threshold VVT3, it indicates that a relatively large vibration has occurred in the display panel 110 in the second direction (that is, the direction D2) of the vertical direction (that is, the directions D1 and D2) (that is, an amplitude of the display panel 100 vibrating downward is relatively large).

In this condition, as shown in FIG. 2E, the source driver 150 may select the gate drive circuit GOA5 among the multiple gate drive circuits GOA1 to GOA_N as a selected gate drive circuit according to the control signal CS1, and transmit the start signal ST5 to the selected gate drive circuit GOA5.

Next, as shown in the timing diagram of FIG. 3E, the multiple gate drive circuits GOA5 to GOAN in the gate driver 160 may generate the multiple gate drive signals GS5 to GSN that are sequentially enabled to the multiple gate lines GL5 to GLN of the display panel 110 according to the start signal ST5 in order to drive multiple pixels respectively corresponding to the multiple gate lines GL5 to GLN in the screen display region IDA. In this way, the display panel 110 may display a screen in the screen display region IDA according to the multiple gate drive signals GS5 to GSN that are sequentially enabled and multiple display data.

Furthermore, in the embodiment, when the control signal CS1 indicates that a relatively large vibration has occurred in the display panel 110 in the second direction D2 of the vertical direction, the source driver 150 may adjust to transmit the start signal ST (that is, the start signal ST3, the start signal ST4 or the start signal ST5) to the selected gate drive circuit GOA5 instead of to the selected gate drive circuit GOA3 (or the selected gate drive circuit GOA4) according to the control signal CS1. In the gate driver 160, the gate drive circuit GOA5 may be disposed below the gate drive circuit GOA3 (or the gate drive circuit GOA4).

In this way, in the operating scenarios of FIG. 2C and FIG. 2E, the source driver 150 may adjust to transmit the start signal ST to the selected gate drive circuit GOA5 instead of to the selected gate drive circuit GOA3 to allow the screen display region IDA of the display panel 110 to move (that is, move downward) along the second direction D2 with a fourth movement amplitude MR4 from an originally set position. The fourth movement amplitude MR4 may be greater than the third movement amplitude MR3.

According to the embodiments of FIG. 2A to FIG. 2E, it can be understood that the controller 140 may determine the vertical vibration level VVD1 (or the vertical vibration level VVD2) of the display panel 110 in the first direction D1 (or the second direction D2) of the vertical direction according to the vibration information VI, and generate the corresponding control signal CS1 to the source driver 150. The controller 140 may, based on the vertical vibration level VVD1 (or the vertical vibration level VVD2), control the source driver 150 through the control signal CS1 to select to transmit the start signal ST to a selected gate drive circuit in the gate driver 160. In this way, the display device 100 may adjust a position of the screen display region IDA of the display panel 100 in the vertical direction according to a position of the selected gate drive circuit that receives the start signal ST.

Furthermore, when the vibration information VI or the control signal CS1 indicates that the display panel 110 vibrates along the first direction D1 (that is, upward) of the vertical direction, the display device 100 may, according to a position of the selected gate drive circuit that receives the start signal ST, move the screen display region IDA of the display panel 110 along the first direction D1 (that is, upward) from an originally set position. When the vibration information VI or the control signal CS1 indicates that the display panel 110 vibrates along the second direction D2 (that is, downward) of the vertical direction, the display device 100 may, according to a position of the selected gate drive circuit that receives the start signal ST, move the screen display region IDA of the display panel 110 along the second direction D2 (that is, downward) from the originally set position.

In this way, when the display panel 110 vibrates along a vertical direction, the display device 100 may compensate a display screen in the vertical direction through the foregoing description. A direction of movement of the display screen observed by the user may match an expected sensory message, thereby improving the motion sickness phenomenon caused by wobbling of the display device 100 in order to enhance the viewing quality of the display screen.

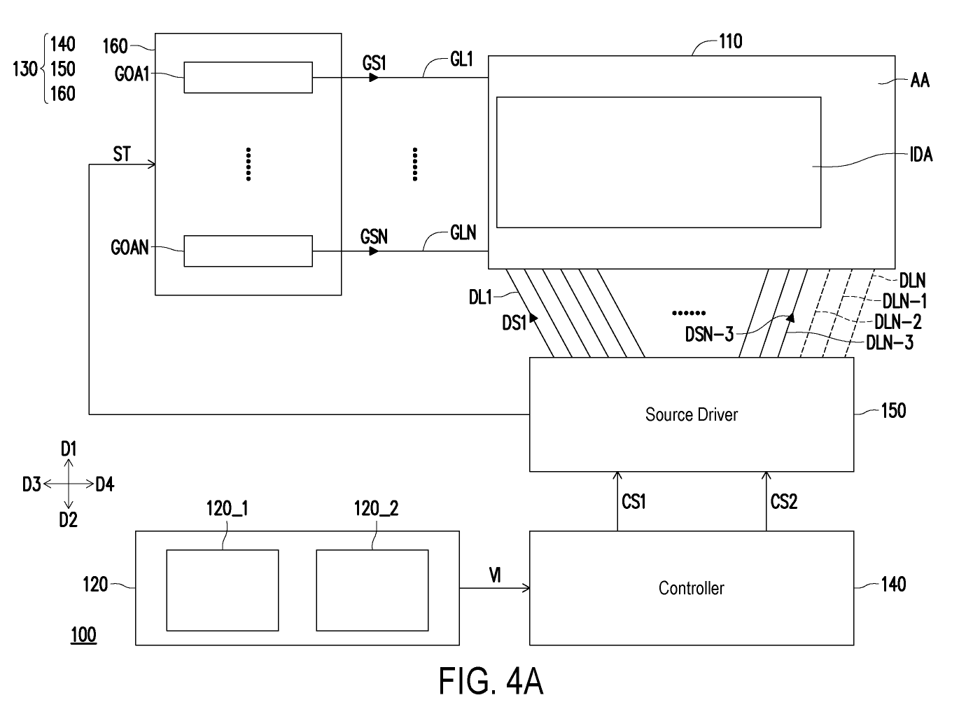

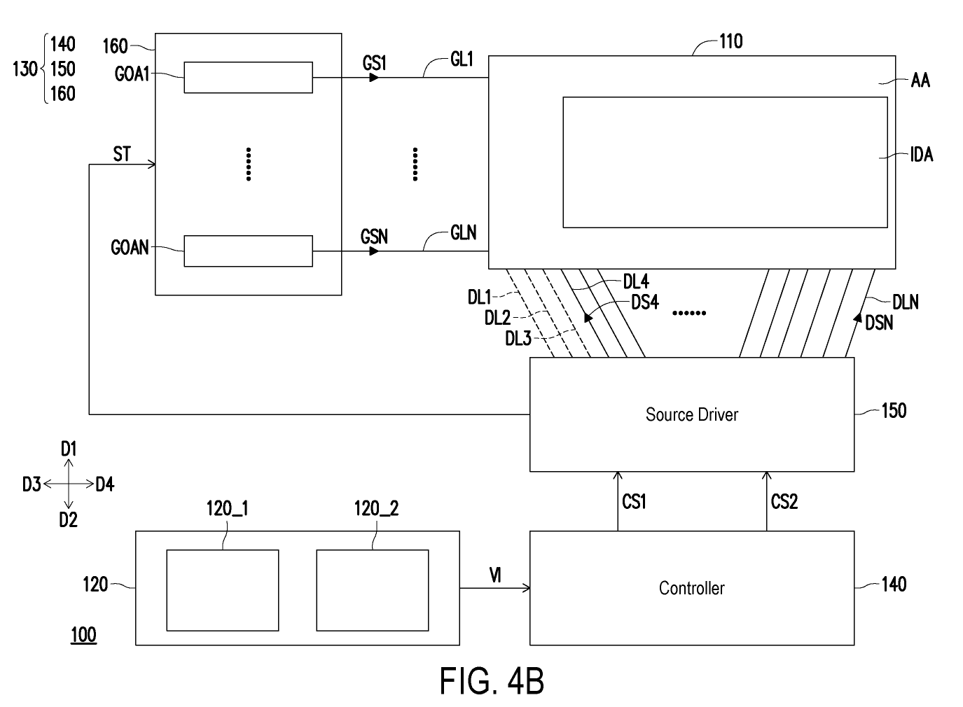

FIG. 4A to FIG. 4B are schematic diagrams of operating scenarios when the display panel vibrates in a horizontal direction according to the embodiments of FIG. 1. In the embodiments of FIG. 4A to FIG. 4B, the embodiments of FIG. 4A to FIG. 4B may be adapted to operating scenarios or scenes where a vibration level of the display panel 110 in a horizontal direction is more intense, but a vibration level in a vertical direction is more moderate. For example, the display device 100 is applied to a car window type transparent display.

In this regard, please refer to FIG. 4A to FIG. 4B at the same time. In detail, in a display time interval of an image frame of the display device 100, when the sensor 120_2 of the sensing device 120 senses that the display panel 110 vibrates along a first direction (that is, the direction D3) of the horizontal direction (that is, the directions D3 and D4) with a vibration level HVD1, the sensor 120_2 may generate the vibration information VI to the controller 140 according to the vibration level HVD1 of the display panel 110 in the first direction D3.

Next, the controller 140 may compare the horizontal vibration level HVD1 with a preset horizontal vibration threshold HVT according to the vibration information VI, and generate the control signal CS2 to the source driver 150 according to a comparison result.

For example, when the controller 140 determines that the horizontal vibration level HVD1 of the display panel 110 is not greater than the horizontal vibration threshold HVT, it indicates that no obvious vibration state has occurred in the display panel 110 in the horizontal direction. In this condition, the source driver 150 may generate multiple display data to the display panel 110 according to the control signal CS2 to allow the screen display region IDA of the display panel 110 to display a corresponding display screen according to the multiple display data and multiple gate drive signals.

In the embodiment, a center position of the screen display region IDA of the display panel 110 may be disposed to overlap with a center position of the displayable region AA of the display panel 110 according to an originally set ratio (as shown in the display panel 110 of FIG. 2C).

On the other hand, when the controller 140 determines that the horizontal vibration level HVD1 of the display panel 110 is greater than the horizontal vibration threshold HVT, it indicates that an obvious vibration state has occurred in the display panel 110 in the first direction (that is, the direction D3) of the horizontal direction.

In this condition, as shown in FIG. 4A, the source driver 150 may transmit multiple display data DS1 to DSN-3 to multiple first source lines (that is, the source line DL1 to a source line DLN-3) of the multiple source lines DL1 to DLN of the display panel 110 according to the control signal CS2 (or the horizontal vibration level HVD1). The source driver 150 may write the display data DS1 to DSN-3 into multiple pixels respectively corresponding to the multiple first source lines DL1 to DLN-3 in the screen display region IDA. In this way, the display panel 110 may display a screen in the screen display region IDA according to multiple gate drive signals that are sequentially enabled and the multiple display data DS1 to DSN-3.

It is worth mentioning that, in the embodiment of FIG. 4A, the source driver 150 does not transmit the display data to the source lines DLN-2 to DLN of the display panel 110 (that is, the source lines DLN-2 to DLN are represented by dashed lines as shown in FIG. 4A). Therefore, the displayable region AA corresponding to multiple pixels on the source lines DLN-2 to DLN may not display a screen.

Furthermore, in the operating scenario of FIG. 4A, when the vibration information VI or the control signal CS2 indicates that the display panel 110 vibrates along the first direction D3 (that is, towards the left) of the horizontal direction, the source driver 150 may transmit the multiple display data DS1 to DSN-3 to the multiple first source lines DL1 to DLN-3 of the display panel 110 to allow the screen display region IDA of the display panel 110 to move along the first direction D3 (that is, towards the left) from an originally set position.

On the other hand, when the sensor 120_2 of the sensing device 120 senses that the display panel 110 vibrates along a second direction (that is, the direction D4) of the horizontal direction (that is, the directions D3 and D4) with a vibration level HVD2, the sensor 120_2 may generate the vibration information VI to the controller 140 according to the vibration level HVD2 of the display panel 110 in the second direction D4.

Next, the controller 140 may compare the horizontal vibration level HVD2 with the preset horizontal vibration threshold HVT according to the vibration information VI, and generate the control signal CS2 to the source driver 150 according to a foregoing comparison result.

For example, when the controller 140 determines that the horizontal vibration level HVD2 of the display panel 110 is greater than the horizontal vibration threshold HVT, it indicates that an obvious vibration state has occurred in the display panel 110 in the second direction (that is, direction D4) of the horizontal direction.

In this condition, as shown in FIG. 4B, the source driver 150 may transmit the multiple display data DS4 to DSN to multiple second source lines (that is, the source lines DL4 to DLN) of the multiple source lines DL1 to DLN of the display panel 110 according to the control signal CS2 (or the horizontal vibration level HVD2). The source driver 150 may write the display data DS4 to DSN into multiple pixels respectively corresponding to the multiple second source lines DL4 to DLN in the screen display region IDA. In this way, the display panel 110 may display a screen in the screen display region IDA according to multiple gate drive signals that are sequentially enabled and the multiple display data DS4 to DSN.

It is worth mentioning that, in the embodiment of FIG. 4B, the source driver 150 does not transmit the display data to the source lines DL1 to DL3 of the display panel 110 (that is, the source lines DL1 to DL3 are represented by dashed lines as shown in FIG. 4B). Therefore, the displayable region AA corresponding to multiple pixels on the source lines DL1 to DL3 may not display a screen.

Furthermore, in the operating scenario of FIG. 4B, when the vibration information VI or the control signal CS2 indicates that the display panel 110 vibrates along the second direction D4 (that is, towards the right) of the horizontal direction, the source driver 150 may transmit the multiple display data DS4 to DSN to the multiple second source lines DL4 to DLN of the display panel 110 to allow the screen display region IDA of the display panel 110 to move along the second direction D4 (that is, towards the right) from an originally set position.

According to the embodiments from FIG. 4A to FIG. 4B, it can be understood that when the vibration information VI or the control signal CS2 indicates that the display panel 110 vibrates along the horizontal direction, the source driver 150 may adjust to transmit the multiple display data to the multiple second source lines DL4 to DLN of the multiple source lines DL1 to DLN instead of to the multiple first source lines DL1 to DLN-3 of the multiple source lines DL1 to DLN according to the control signal CS2. Among the multiple source lines DL1 to DLN of the display panel 110, a distribution range of the first source lines DL1 to DLN-3 and a distribution range of the second source lines DL4 to DLN partially overlap. A quantity of the first source lines DL1 to DLN-3 is equal to a quantity of the second source lines DL4 to DLN.

In this way, when the display panel 110 vibrates along the horizontal direction, the display device 100 may compensate a display screen in the horizontal direction through the foregoing description. A direction of movement of the display screen observed by the user may match an expected sensory message, thereby improving the motion sickness phenomenon caused by wobbling of the display device 100 in order to enhance the viewing quality of the display screen.

Incidentally, in addition to the foregoing embodiment, in some other embodiments, the display device 100 may also be adapted to operating scenarios or scenes where a vibration level of the display panel 110 in forward and backward directions is more intense, but a vibration level in up, down, left, and right directions is more moderate. For example, the display device 100 is applied to a seat-back display in a car seat or an airplane seat, etc.

Specifically, the display device 100 may, according to the various embodiments of compensating the display screen in the vertical direction and the horizontal direction, allow the display controller and driver 130 to adjust a dimension of the screen display region IDA of the display panel 110 (that is, proportionally enlarge or shrink) based on changes in a moving speed of the display device 100 and according to a vibration level of the display panel 110 in the forward and backward directions.

For example, when the vehicle performs an acceleration operation, the display controller and driver 130 may proportionally enlarge the screen display region IDA of the display panel 110 according to a vibration level of the display panel 110 in the forward and backward directions. When the vehicle performs a deceleration operation, the display controller and driver 130 may proportionally shrink the screen display region IDA of the display panel 110 according to a vibration level of the display panel 110 in the forward and backward directions.

In some other embodiments, the display device 100 may also be adapted to operating scenarios or scenes where an intense vibration has occurred in the display panel 110 in the horizontal direction and the vertical direction at the same time. For example, when a user needs to ride a transportation vehicle for a long time and may not determine a type of wobble for the traffic thereof. In this condition, the display device 100 may adjust a position of the screen display region IDA according to the foregoing various embodiments of compensating a display screen in a vertical direction and a horizontal direction.

According to the foregoing descriptions of the various operating scenarios, it can be understood that unlike prior art that compensates an output display screen through software technology, the display device 100 of the embodiment can achieve the effect of adjusting a position of a display screen by adjusting a distribution range of hardware input signals. With this design, the display device 100 does not need additional software to perform algorithmic calculation, thereby significantly reducing the need for hardware computing capability and significantly decreasing the overall computation time to avoid a condition where there is a gap between the display screen and an actual time.

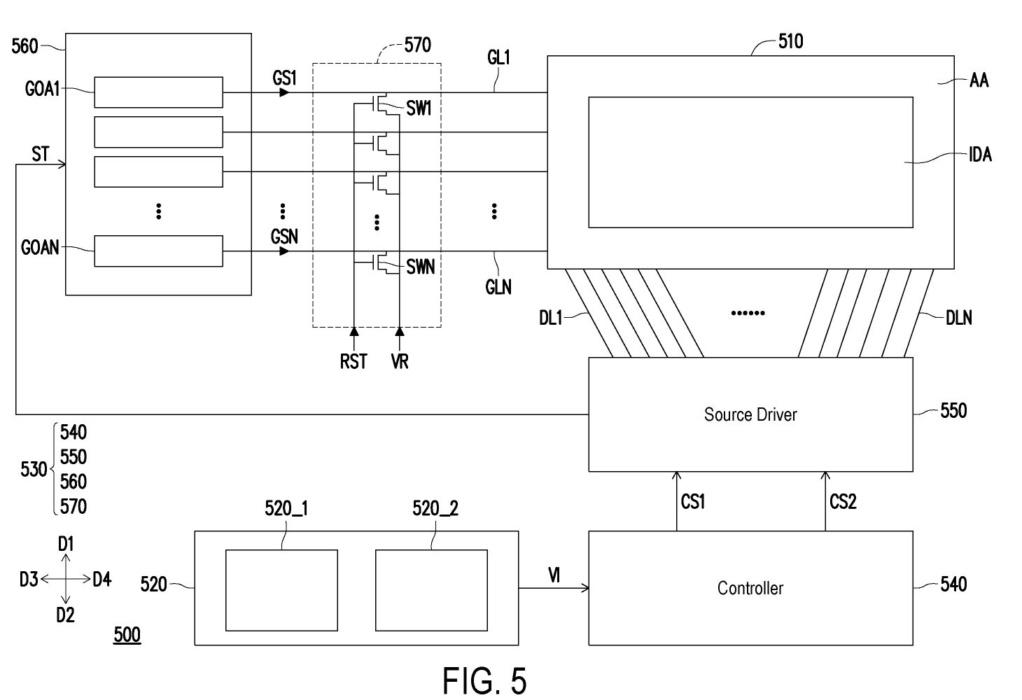

FIG. 5 is a schematic diagram of a display device according to another embodiment of the disclosure. Please refer to FIG. 5. In the embodiment shown in FIG. 5, a display device 500 includes a display panel 510, a sensing device 520, and a display controller and driver 530. The sensing device 520 includes a sensor 520_1 and a sensor 520_2.

It should be noted that the display device 500, the display panel 510, the sensing device 520, and the display controller and driver 530 shown in FIG. 5 may be deduced by referring to the related description of the display device 100, the display panel 110, the sensing device 120, and the display controller and driver 130 mentioned in FIG. 1, FIG. 2A to FIG. 2E, FIG. 3A to FIG. 3E, and FIG. 4A to FIG. 4B, so the detail will not be repeated here.

It is different from the embodiment in FIG. 1 that, in the display device 500 shown in FIG. 5, the display controller and driver 530 may include a controller 540, a source driver 550, a gate driver 560, and a reset circuit 570.

In the embodiment, the reset circuit 570 is coupled to multiple gate lines GL1 to GLN of the display panel 510, the source driver 550, and multiple gate drive circuits GOA1 to GOAN of the gate driver 560. The reset circuit 570 may receive a reset signal RST from the source driver 550.

Specifically, the reset circuit 570 includes multiple switches SW1 to SWN. A control end of each switch among the switches SW1 to SWN may receive the reset signal RST. A first end of each switch among the switches SW1 to SWN may receive a reset voltage VR. A second end of each switch among the switches SW1 to SWN may be coupled to each corresponding gate line among the multiple gate lines GL1 to GLN. The switches SW1 to SWN may be implemented with N-type metal-oxide-semiconductor field-effect transistors, but the disclosure is not limited thereto.

Furthermore, in the embodiment, before the display device 500 ends each display time interval of an image frame, the reset circuit 570 may provide the multiple reset voltages VR to the multiple gate lines GL1 to GLN according to the reset signal RST to respectively perform a reset operation on multiple pixel voltages of multiple pixels of the display panel 510. In this way, the display panel 510 may effectively reduce the chance of afterimage during a display time interval of each image frame.

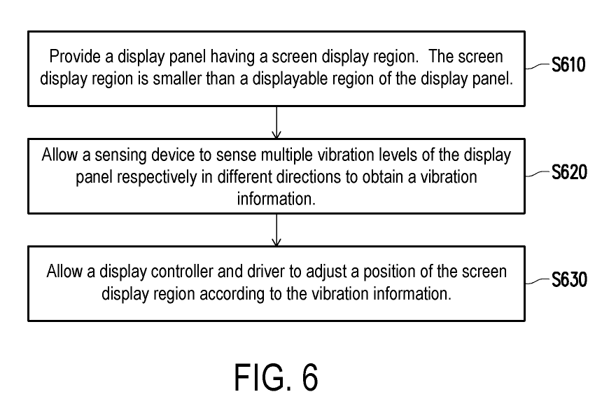

FIG. 6 is a flow chart of a method of operating a display device according to an embodiment of the disclosure. Please refer to FIG. 1 and FIG. 6 at the same time. In step S610, a display device provides a display panel having a screen display region. The screen display region is smaller than a displayable region of the display panel. In step S620, the display device allows a sensing device to sense multiple vibration levels of the display panel in different directions to obtain a vibration information. In step S630, the display device allows the display controller and driver to adjust a position of the screen display region according to the vibration information.

Regarding the implementation details of each of the foregoing steps, there are thorough descriptions in the foregoing embodiments and implementation methods, so the detail will not be repeated here.

In summary, the display device and the operating method thereof according to the embodiments of the disclosure may move the screen display region of the display panel along a direction of vertical vibration from an originally set position based on a position of a selected gate drive circuit that receives a start signal to compensate a display screen in a vertical direction when the display panel vibrates along the vertical direction. The display device may adjust to transmit multiple display data to multiple second source lines instead of to multiple first source lines to compensate the display screen in the horizontal direction. In this way, a direction of movement of the display screen observed by the user may match an expected sensory message, thereby improving the motion sickness phenomenon caused by wobbling of the display device in order to enhance the viewing quality of the display screen.

What is claimed is:

1. A display device, comprising:
a display panel, having a screen display region, wherein the screen display region is smaller than a displayable region of the display panel;
a sensing device, configured to sense a plurality of vibration levels of the display panel respectively in different directions to obtain a vibration information; and
a display controller and driver, coupled to the display panel and the sensing device, and configured to adjust a position of the screen display region according to the vibration information, wherein the display controller and driver comprises:
a gate driver, configured to adjust a position on the display panel to which a plurality of gate drive signals are transmitted according to the vibration information;
a source driver, configured to adjust a position on the display panel to which a plurality of display data are transmitted according to the vibration information; and
a reset circuit, coupled to the source driver, the gate driver and the display panel, and configured to receive a reset signal and provide a plurality of reset voltages according to the reset signal to respectively reset a plurality of pixel voltages of a plurality of pixels of the display panel.

2. The display device according to claim 1, wherein when the vibration information indicates that the display panel vibrates along a horizontal direction, the display controller and driver adjusts to transmit the display data to a plurality of second source lines instead of to a plurality of first source lines, wherein a distribution range of the first source lines and a distribution range of the second source lines partially overlap, and a quantity of the first source lines is equal to a quantity of the second source lines.

3. The display device according to claim 1, wherein when the vibration information indicates that the display panel vibrates along a vertical direction, the display controller and driver adjusts to transmit a start signal to a second gate drive circuit instead of to a first gate drive circuit.

4. The display device according to claim 3, wherein the first gate drive circuit is disposed above or below the second gate drive circuit according to a vibration direction of the vibration information.

5. The display device according to claim 1, wherein the display controller and driver comprises:
a controller, coupled to the sensing device, and configured to generate a first control signal according to a comparison between a first vibration level of the vibration information and a first vibration threshold and generate a second control signal according to a comparison between a second vibration level of the vibration information and a second vibration threshold;
the gate driver, coupled to a plurality of gate lines of the display panel, wherein the gate driver has a plurality of gate drive circuits, and the gate drive circuits drive the screen display region according to a start signal; and
the source driver, coupled to the display panel, the controller and the gate driver, and configured to generate the start signal to the gate driver according to the first control signal and generate the display data to a plurality of first source lines and a plurality of second source lines of the display panel according to the second control signal.

6. The display device according to claim 5, wherein when the controller generates the second control signal indicating that the display panel vibrates along a horizontal direction, the source driver transmits the display data to the second source lines instead of to the first source lines according to the second control signal, wherein a distribution range of the first source lines and a distribution range of the second source lines partially overlap, and a quantity of the first source lines is equal to a quantity of the second source lines.

7. The display device according to claim 5, wherein when the controller generates the second control signal indicating that the display panel vibrates along a vertical direction, the source driver transmits the start signal to a second gate drive circuit among the gate drive circuits instead of to a first gate drive circuit among the gate drive circuits according to the second control signal.

8. A method of operating a display device, comprising:
providing a display panel having a screen display region, wherein the screen display region is smaller than a displayable region of the display panel;
allowing a sensing device to sense a plurality of vibration levels of the display panel respectively in different directions to obtain a vibration information;
allowing a display controller and driver to adjust a position of the screen display region according to the vibration information;
allowing a gate driver of the display controller and driver to adjust a position on the display panel to which a plurality of gate drive signals are transmitted according to the vibration information;
allowing a source driver of the display controller and driver to adjust a position on the display panel to which a plurality of display data are transmitted according to the vibration information; and
allowing a reset circuit of the display controller and driver to receive a reset signal, and allowing the reset circuit to provide a plurality of reset voltages according to the reset signal to respectively reset a plurality of pixel voltages of a plurality of pixels of the display panel.

9. The method according to claim 8, wherein the step of allowing the display controller and driver to adjust the position of the screen display region according to the vibration information comprises:
allowing the display controller and driver to adjust to transmit the display data to a plurality of second source lines instead of to a plurality of first source lines when the vibration information indicates that the display panel vibrates along a horizontal direction, wherein a distribution range of the first source lines and a distribution range of the second source lines partially overlap, and a quantity of the first source lines is equal to a quantity of the second source lines.

10. The method according to claim 8, wherein the step of allowing the display controller and driver to adjust the position of the screen display region according to the vibration information comprises:
allowing the display controller and driver to adjust to transmit a start signal to a second gate drive circuit instead of to a first gate drive circuit when the vibration information indicates that the display panel vibrates along a vertical direction.

11. The method according to claim 10, wherein the first gate drive circuit is disposed above or below the second gate drive circuit according to a vibration direction of the vibration information.

12. The method according to claim 10, further comprising:
allowing a controller of the display controller and driver to generate a first control signal according to a comparison between a first vibration level of the vibration information and a first vibration threshold, and generate a second control signal according to a comparison between a second vibration level of the vibration information and a second vibration threshold;
allowing the gate driver of the display controller and driver to drive the screen display region according to the start signal; and
allowing the source driver of the display controller and driver to generate the start signal to the gate driver according to the first control signal, and generate the display data to a plurality of first source lines and a plurality of second source lines of the display panel according to the second control signal.

13. The method according to claim 12, wherein when the controller generates the second control signal indicating that the display panel vibrates along a horizontal direction, the source driver is allowed to transmit the display data to the second source lines instead of to the first source lines according to the second control signal, wherein a distribution range of the first source lines and a distribution range of the second source lines partially overlap, and a quantity of the first source lines is equal to a quantity of the second source lines.

14. The method according to claim 12, wherein when the controller generates the second control signal indicating that the display panel vibrates along a vertical direction, the source driver is allowed to transmit the start signal to the second gate drive circuit among the gate drive circuits instead of to the first gate drive circuit among the gate drive circuits according to the second control signal.
